(19) United States
(12) Patent Application Publication
(10) Pub. No.: US 2014/0281434 A1
(43) Pub. Date: Sep. 18, 2014

(54) PATH PROFILING USING HARDWARE AND SOFTWARE COMBINATION

(71) Applicants: Carlos Madriles, Barcelona (ES); Josep M. Codina, Hospitalet de Llobregat (ES); Christos E Kotselidis, Barcelona (ES); Alejandro Martinez Vicente, Barcelona (ES)

(72) Inventors: Carlos Madriles, Barcelona (ES); Josep M. Codina, Hospitalet de Llobregat (ES); Christos E Kotselidis, Barcelona (ES); Alejandro Martinez Vicente, Barcelona (ES)

(21) Appl. No.: 13/994,193

(22) PCT Filed: Mar. 15, 2013
(86) PCT No.: PCT/US2013/032532

§ 371 Date: Jun. 14, 2013

(51) Int. Cl. G06F 9/30

(52) U.S. Cl. CPC G06F 9/30145
USPC 712/227

(57) ABSTRACT

A mechanism for generating a path profile is disclosed. A profiling module may insert profiling instructions into instruction blocks. The profiling instructions may generate a path identifier as a processor executes an execution path executes a sequence or path of instruction blocks). A path identifier module may add path identifiers to path identifier data, such as a table, and may track the number of times an execution path associated with the path identifier is executed. The profiling module may periodically copy and/or modify the path identifier data and may generate a path profile based on the path identifier data

Embodiments described herein generally relate to processing devices and, more specifically, relate to path profiling.

Systems may use profiling information, such as a path profile, to generate better executable code and/or instructions. For example, compilers, just-in-time (JIT) compilers, dynamic binary translators, etc., may use a path profile to generate code and/or instructions more efficiently and/or more quickly. Path profiling information can be very useful in several scenarios. For example, software/hardware co-designed machines may include a software layer that emulates, translates and optimizes instructions on top of a simple hardware design. In a co-designed machine, accurate path profiling information may be useful for aggressive optimizations like speculative control-flow versioning and/or may provide better insight on the which regions of instructions to select for optimization. Path profiling may also be useful for JIT compilers, such as the Java® Virtual Machine or Microsoft® Common Language Runtime (CLR) virtual machine. A JIT compiler may be a software layer that emulates and optimizes instructions from a portable ISA (bytecode) to the native ISA that the virtual machine is running on. JIT compilers may perform path-based optimizations and trace scheduling that may benefit for having accurate path profiling information (e.g., from having accurate path profiles). Regular compilers may also use path profiles to perform optimizations that generate more compact and efficient binaries. For example, a compiler may use path profiling to perform dead code removal and common sub-expression elimination. Another use of profiling information is to identify heavily executed paths (e.g., blocks of instructions that are constantly executed by a processor or “hot paths-”) for performance tuning and program optimization. Path profiling may be used in order to obtain accurate information of executed paths.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram of the micro-architecture for a processor 200 that includes logic circuits to perform instructions in accordance with one embodiment of the present invention.

FIG. 2 is a block diagram illustrating an in-order pipeline and a register renaming stage, out-of-order issue/execution pipeline.

FIG. 3 is a block diagram illustrating an in-order architecture core and a register renaming logic, out-of-order issue/execution logic to be included in a processor according to at least one embodiment of the disclosure.

FIG. 4 is a block diagram of a computer system according to one implementation.

FIG. 5 is a block diagram of an application including multiple instruction blocks, according to one embodiment of the disclosure.

FIG. 6 is table illustrating example path identifier data, according to one embodiment of the disclosure.

FIG. 7 is a block diagram of a system architecture for generating a path profile, according to one embodiment of the disclosure.

FIG. 8 is a block diagram illustrating a profiling module for generating a path profile, according to an embodiment of the disclosure.

FIG. 9 is a block diagram illustrating a path identifier module for tracking execution paths, according to an embodiment of the disclosure.

FIG. 10 is a flow diagram illustrating a method generating a path profile, according to one embodiment of the disclosure.

FIG. 11 is a flow diagram illustrating a method of tracking execution paths, according to one embodiment of the disclosure,

FIG. 12 is a block diagram of a system on chip (SoC) in accordance with an embodiment of the present disclosure.

FIG. 13 is a block diagram of an embodiment of a system on-chip (SOC) design in accordance with the present disclosure.

FIG. 14 illustrates a diagrammatic representation of a machine in the example form of a computer system within which a set of instructions, for causing the machine to perform any one or more of the methodologies discussed herein, may be executed.

Current platforms or systems for path profiling may incur larger overheads, which makes them unfeasible for run-time systems, like dynamic binary translators and JIT compilers, and unappealing for static or regular compilers. The current platforms may incur overheads because profiling information may be gathered mainly by a software component (e.g., an application) through the execution of additional instructions. This extra overhead may have detrimental effects such as: (i) using simple profiling model, or (ii) profiling during a small time window. These two solutions may sacrifice profiling accuracy in order to reduce the overhead to obtain profiling information. Many of the current platforms may profile the execution frequency of instruction blocks (e.g., groups of instructions) and branch destinations (edge profiling).

As discussed above, path profiling may be useful in a variety of situations. Embodiments of the disclosure provide for generating a path profile. In one embodiment, a profiling module may insert profiling instructions into instruction blocks, The profiling instructions may generate. a path identifier as a processor executes an execution path (e.g., executes a sequence or path of instruction blocks), A path identifier module may add path identifiers to path identifier data, such as a table, and may track the number of times an execution path associated with the path identifier is executed. The profiling module may periodically copy and/or modify the path identifier data and may generate a path profile based on the path identifier data.

In one embodiment, both hardware and software are used to generate the path profile. The path identifier module may be a more simple hardware component that stores the path identifiers and counters for each of the path identifiers. The profiling module may be a software component that identifies regions of code to profile, inserts lightweight profiling instructions, determines how the path identifiers and counters in the path identifier module should be updated, deleted, and/or overwritten, and generates the path profile. This may leave the determination of what regions of code to profile and how to profile to the profiling module and may incur less overhead due to the lightweight profiling instructions and the simple hardware support.

Although the following embodiments may be described with reference to specific integrated circuits, such as in computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to desktop computer systems or Ultrabooks™. And may be also used in other devices, such as handheld. devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below.

Although the following embodiments are described with reference to a processor, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

FIG. 1 is a block diagram of the micro-architecture for a processor 200 that includes logic circuits to perform instructions in accordance with one embodiment of the present invention. In some embodiments, an instruction in accordance with one embodiment can be implemented to operate on data elements having sizes of byte, word, doubleword, quadword, etc., as well as datatypes, such as single and double precision integer and floating point datatypes. In one embodiment, the processor 200 may execute a profiling module (e.g., profiling 330 illustrated in FIG. 7). In one embodiment, the processor 200 may also include a path identifier module (e.g., path identifier module 340 illustrated in FIG. 7). For example, the path identifier module may be part of the front end 201 and/or the out of order engine 203. In one embodiment the in-order front end 201 is the part of the processor 200 that fetches instructions to be executed and prepares them to be used later in the processor pipeline. The front end 201 may include several units. in one embodiment, the instruction prefetcher 226 fetches instructions from memory and feeds them to an instruction decoder 228 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 230 takes decoded uops and assembles them into program ordered sequences or traces in the uop queue 234 for execution. When the trace cache 230 encounters a complex instruction, the microcode ROM 232 provides the uops needed to complete the operation.

Some instructions are converted into a single micro-op, whereas others need several micro-ops to complete the full operation. In one embodiment, if more than four micro-ops are needed to complete an instruction, the decoder 228 accesses the microcode ROM 232 to do the instruction. For one embodiment, an instruction can be decoded into a small number of micro ops for processing at the instruction decoder 228. In another embodiment, an instruction can be stored within the microcode ROM 232 should a number of micro-ops be needed to accomplish the operation. The trace cache 230 refers to an entry point programmable logic array (PLA) to determine a correct micro-instruction pointer for reading the micro-code sequences to complete one or more instructions in accordance with one embodiment from the micro-code ROM 232. After the microcode ROM 232 finishes sequencing, micro-ops for an instruction, the front end 201 of the machine resumes fetching micro-ops from the trace cache 230.

The out-of-order execution engine 203 is where the instructions are prepared for execution, The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 202, slow/general floating point scheduler 204, and simple floating point scheduler 206. The uop schedulers 202, 204, 206, determine when a uop is ready to execute based on the readiness of their dependent input register operand sources and the availability of the execution resources the uops need to complete their operation. The fast scheduler 202 of one embodiment can schedule on each half of the main clock cycle while the other schedulers can only schedule once per main processor clock cycle. The schedulers arbitrate for the dispatch ports to schedule uops for execution.

Register files 208, 210, sit between the schedulers 202, 204, 206, and the execution units 212, 214, 216, 218, 220, 222, 224 in the execution block 211. There is a separate register file 208, 210, for integer and floating point operations, respectively. Each register file 208, 210, of one embodiment also includes a bypass network that can bypass or forward just completed results that have not yet been written into the register file to new dependent uops. The integer register file 208 and the floating point register file 210 are also capable of communicating data with the other. For one embodiment, the integer register file 208 is split into two separate register files, one register file for the low order 32 bits of data and a second register file for the high order 32 bits of data. The floating point register file 210 of one embodiment has 128 bit wide entries because floating point instructions typically have operands from 64 to 128 bits in width.

The execution block 211 contains the execution units 212, 214, 216, 218, 220, 222, 224, where the instructions are actually executed. This section includes the register files 208, 210, that store the integer and floating point data operand values that the micro-instructions need to execute. The processor 200 of one embodiment is comprised of a number of execution units: address generation unit (AGU) 212, AGU 214, fast ALU 216, fast ALU 218, slow ALU 220, floating point ALU 222, floating point move unit 224. For one embodiment, the floating point execution blocks 222, 224, execute floating point, MMX, SIMD, and SSE, or other operations. The floating point ALU 222 of one embodiment includes a 64 bit by 64 bit floating point divider to execute divide, square root, and remainder micro-ops. For embodiments of the present invention, instructions involving a floating point value may be handled with the floating point hardware. In one embodiment, the ALU operations go to the high-speed ALU execution units 216, 218. The fast ALUs 216, 218, of one embodiment can execute fast operations with an effective latency of half a clock cycle. For one embodiment, most complex integer operations go to the slow ALU 220 as the slow ALU 220 includes integer execution hardware for long latency type of operations, such as a multiplier, shifts, flag logic, and branch processing. Memory load/store operations are executed by the AGUs 212, 214. For one embodiment, the integer ALUs 216, 218, 220, are described in the context of performing integer operations on 64 bit data operands. In alternative embodiments, the ALUs 216, 218, 220, can be implemented to support a variety of data bits including 16, 32, 128, 256, etc. Similarly, the floating point units 222, 224, can be implemented to support a range of operands having bits of various widths. For one embodiment, the floating point units 222, 224, can operate on 128 bits wide packed data operands in conjunction with SIMD and multimedia instructions.

In one embodiment, the uops schedulers 202, 204, 206, dispatch dependent operations before the parent load has finished executing. As uops are speculatively scheduled and executed in processor 200, the processor 200 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIM registers for packed data. For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

FIG. 2 is a block diagram illustrating an in-order pipeline and a register renaming stage, out-of-order issue/execution pipeline implemented by processing device 1500 of FIG. 3. FIG. 2 is a block diagram illustrating an in-order architecture core and a register renaming logic, out-of-order issue/execution logic to be included in a processor according to at least one embodiment of the invention. The solid lined boxes in FIG. 2 illustrate the in-order pipeline, while the dashed lined boxes illustrates the register renaming, out-of-order issue/execution pipeline. Similarly, the solid lined boxes in FIG. 2 illustrate the in-order architecture logic, while the dashed lined boxes illustrates the register renaming logic and out-of-order issue/execution logic. in FIG. 2, a processor pipeline 1400 includes a fetch stage 1402, a length decode stage 1404, a decode stage 1406, an allocation stage 1408, a renaming stage 1410, a scheduling (also known as a dispatch or issue) stage 1412, a register read/memory read stage 1414, an execute stage 1416, a write back/memory write stage 1418, an exception handling stage 1422, and a commit stage 1424.

FIG. 3 is a block diagram illustrating an in-order architecture core and a register renaming logic, out-of-order issue/execution logic to be included in a processor according to at least one embodiment of the disclosure. In FIG. 3, arrows denote a coupling between two or more units and the direction of the arrow indicates a direction of data flow between those units. FIG. 3 shows processor core 1590 including a front end unit 1530 coupled to an execution engine unit 1550, and both are coupled to a memory unit 1570. In one embodiment, path identifier data (e.g., table 290 illustrated in FIG. 6) may be stored in the memory unit 1570.

The core 1590 may be a reduced instruction set computing (RISC) core, a complex instruction set computing (CISC) core, a very long instruction word (VLIW) core, or a hybrid or alternative core type. As yet another option, the core 1590 may be a special-purpose core, such as, for example, a network or communication core, compression engine, graphics core, or the like. In one embodiment, core 1590 may execute a profiling module (e.g., profiling module 330 illustrated in FIG. 7). In another embodiment, a path identifier module (e.g., path identifier 340 illustrated in FIG. 7) may be included in or may be part of the core 1590. For example, the path identifier module may be part of the front end unit 1530 and/or execution engine unit 1550.

The front end unit 1530 includes a branch prediction unit 1532 coupled to an instruction cache unit 1534, which is coupled to an instruction translation lookaside buffer (TLB) 1536, which is coupled to an instruction fetch unit 1538, which is coupled to a decode unit 1540. The decode unit or decoder may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc. The instruction cache unit 1534 is further coupled to a level 2 (L2) cache unit 1576 in the memory unit 1570. The decode unit 1540 is coupled to a rename/allocator unit 1552 in the execution engine unit 1550.

The execution engine unit 1550 includes the rename/allocator unit 1552 coupled to a retirement unit 1554 and a set of one or more scheduler unit(s) 1556. The scheduler units) 1556 represents any number of different, schedulers, including reservations stations, central instruction window, etc. The scheduler unit(s) 1556 is coupled to the physical register file(s) unit(s) 1558. Each of the physical register file(s) units 1558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 1558 is overlapped by the retirement unit 1554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.). Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 1554 and the physical register file(s) unit(s) 1558 are coupled to the execution cluster(s) 1560. The execution cluster(s) 1560 includes a set of one or more execution units 162 and a set of one or more memory access units 1564. The execution units 1562 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1556, physical register file(s) unit(s) 1558, and execution cluster(s) 1560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1564). It should also be understood that where separate pipelines are used, one or more of these pipelines may be out-of-order issue/execution and the rest in-order.

The set of memory access units 1564 is coupled to the memory unit 1570, which includes a data TLB unit 1572 coupled to a data cache unit 1.574 coupled to a level 2 (L2) cache unit 1576. In one exemplary embodiment, the memory access units 1564 may include a load unit, a store address unit, and a store data unit, each of which is coupled to the data TLB unit 1572 in the memory unit 1570. The L2 cache unit 1576 is coupled to one or more other levels of cache and eventually to a main memory.

By way of example, the exemplary register renaming, out-of-order issue/execution core architecture may implement the pipeline 1400 as follows: 1) the instruction fetch 1538 performs the fetch and length decoding stages 1402 and 1404; 2) the decode unit 1540 performs the decode stage 1406; 3) the rename/allocator unit 1552 performs the allocation stage 1408 and renaming stage 1410; 4) the scheduler unit(s) 1556 performs the schedule stage 1412; 5) the physical register file(s) unit(s) 1558 and the memory unit 1570 perform the register read/memory read stage 1414; the execution cluster 1560 perform the execute stage 1416; 6) the memory unit. 1570 and the physical register filets) unit(s) 1558 perform the write back/memory write stage 1418; 7) various units may be involved in the exception handling stage 1422; and 8) the retirement unit 1554 and the physical register file(s) unit(s) 1558 perform the commit stage 1424.

The core 1590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of was including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context, of out-of-order execution, it should he understood that register renaming may be used in an in-order architecture. While the illustrated embodiment of the processor also includes a separate instruction and data cache units 1534/1574 and a shared L2 cache unit 1576, alternative embodiments may have a single internal cache for both instructions and data, such as, for example, a level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 4 is a block diagram of a multiprocessor system 1300 in accordance with an implementation. As shown in FIG. 4, multiprocessor system 1300 is a point-to-point interconnect system, and includes a first processor 1370 and a second processor 1380 coupled via a point-to-point interconnect 1350. Each of processors 1370 and 1380 may be some version of the processing device 602 of FIG. 6. As shown in Ha 4, each of processors 1370 and 1380 may be multicore processors, including first and second processor cores (i.e., processor cores 1374a and I374b and processor cores I384a and 1384b), although potentially many more cores may be present in the processors, A processor core may also be referred to as an execution core. The processors each may include hybrid write mode logics in accordance with an embodiment of the present. In one embodiment, one or more of the processors 1370 and 1380 may execute a profiling module (e.g., profiling module 330 illustrated in FIG. 7). In another embodiment, a path identifier module (e.g., path identifier module 340 illustrated in FIG. 7) may be included in or may be part of one or more of the processors 1370 and 1380.

While shown with two processors 1370, 1380, it is to be understood that the scope of the present disclosure is not so limited. In other implementations, one or more additional processors may be present in a given processor.

Processors 1370 and 1380 are shown including integrated memory controller units 1372 and 1382, respectively. Processor 1370 also includes as part of its bus controller units point-to-point (P-P) interfaces 1376 and 1378; similarly, second processor 1380 includes P-P interfaces 1386 and 1.388. Processors 1370, 1380 may exchange information via a point-to-point (P-P) interface 1350 using P-P interface circuits 1378, 1388. As shown in FIG. 4, IMCs 1372 and 1382 couple the processors to respective memories, namely a memory 1332 and a memory 1334, which may be portions of main memory locally attached to the respective processors. In one embodiment, path identifier data (e.g., tables 290 illustrated in FIG. 6) may be stored in one or more of the memories 1332 and 1334.

Processors 1370, 1380 may each exchange information with a chipset 1390 via individual P-P interfaces 1352, 1354 using point to point interface circuits 1376, 1394, 1386, and 1398. Chipset 1390 may also exchange information with a high-performance graphics circuit 1338 via a high-performance graphics interface 1339.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present disclosure is not so limited.

As shown in FIG. 4, various devices 1314 may be coupled to first bus 1316, along with a bus bridge 1318 which couples first bus 1316 to a second bus 1320. In one embodiment, second bus 1320 may be a low pin count (LPC) bus. Various devices may be coupled to second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to second bus 1320. Note that other architectures are possible. For example, instead of the point-to-point architecture of FIG. 4, a system may implement a multi-drop bus or other such architecture.

FIG. 5 is a block diagram of an application 100 including multiple instruction blocks 105 through 150, according to one embodiment of the disclosure. The application 100 may be a program, a software module, a software component, and/or other software element that may be executed by a processing module (e.g., processing module 350 as illustrated in FIG. 8). The application 100 may include a plurality of instructions. The instructions may include program code to cause a processing module (e.g., a processor) to perform activities such as, but not limited to, reading data, writing data, processing data, formulating data, converting data, transforming data, etc. For example, the application 100 may be a binary file and/or an executable file that includes instructions to cause the processing module to execute a media player to play media items (such as digital videos, digital music) or to cause the processing module to execute a web browser. The instructions in the application 100 may be divided into blocks of instructions (e.g., a series or group of instructions), such as instruction blocks 105 through 150. It should be rioted that the instruction blocks 105 through 150 are merely one example of the different instructions and/or instruction blocks that may be included in the application. In other embodiments, the application 100 may include more or less instruction blocks and may each instruction block may lead to one or more different instruction blocks. For example, a first instruction block may branch to one of four destination instruction blocks (not shown in the figures) based on a condition for a BRANCH instruction in the first instruction block.

The instruction blocks 105 through 150 may include a variety of different instructions (e.g., program instructions). For example, the instruction blocks 105 through 150 may include an ADD instruction (to add two or more values), a MULT instruction (to multiple two or more values), an exclusive-OR (XOR) instruction (to exclusive-or two or more values), an AND instruction (to perform a bit-wise and on two or more values), a. store instruction (to store a value in a memory location, such as a register), a JUMP instruction (to direct the flow of execution of the instructions to a particular instruction), a BRANCH instruction (to direct the flow of execution of the instructions to a particular instruction based on one or more conditions, etc.). In one embodiment, the instruction blocks 105 through 150 may be basic blocks, In one embodiment, a basic block may be a group (e.g., a block) of instructions that has one entry point (e.g., one instruction in the basic block is the destination of a JUMP and/or BRANCH instruction) and one exit point (e.g., the last instruction may be a JUMP or a BRANCH instruction to a different basic block).

As discussed above, an application such as application 100 may include many different execution paths. In one embodiment, an execution path may be a sequence (e.g., a path) of instructions and/or instruction blocks in the application 100 that executed by the processing module when a processing module executes the instructions of the application 100. For example, an execution path (e.g., a sequence of instructions and/or instruction blocks executed by the processing module) may start at instruction block 105 (e.g., a starting instruction block), proceed to instruction block 110, proceed to instruction block 115, proceed to instruction block 130, proceed to instruction block 140, proceed to instruction block 145, and proceed to instruction block 150. In another example, an execution path may start at instruction block 105, proceed to instruction block 110, proceed to instruction block 120, proceed to instruction block 130, proceed to instruction block 140, proceed to instruction block 145, and proceed to instruction block 150. Obtaining a path profile of the application 100 may allow a processing module to apply a compiler and/or the processing module to perform optimizations which may allow an application to run more efficiently, more quickly, and/or use less storage space (e.g., smaller binary file for the application).

As illustrated in FIG. 5, instructions blocks 105, 115, 120, 135, 140, and 150 include profiling instructions. A profiling instruction may be any instruction that may be used to track an execution path. For example, instruction block 105 includes profiling instruction PSTART (e.g., a start instruction), instruction block 115 includes profiling instruction PMARK1 instruction block 120 includes profiling instruction PMARK2, instruction block 135 includes profiling instruction PMARK3, instruction block 140 includes profiling instruction PMARK4, and instruction block 150 includes profiling instruction P-END (e.g., an end instruction). In one embodiment, a profiling instruction may be an instruction may be part of an instruction block, may be executed by a processing module, and may be used to track the execution path of an application (e.g., application 100).

In one embodiment, the profiling instructions may be inserted and/or added to the instructions of the application 100 by a profiling module (discussed in more detail below in conjunction with FIGS. 7 and 8). The profiling module may identify a region of instructions (e.g., one or more instruction blocks) in the application 100 to profile. For example, the profiling module may determine that a path profile should be generated for instruction blocks 105 through 150. The profiling module may insert a PSTART instruction (e.g., a start instruction) at the first and/or beginning instruction block for the region (e.g., at a starting instruction block). For example, as illustrated in FIG. 5, the profiling module may insert the PSTART instruction in instruction block 105. The profiling module may also insert a P-END instruction at the last and/or ending instruction block for the region (of instructions) to profile. For example, as illustrated in FIG. 5, the profiling module may insert the P-END instruction in instruction block 150. The profiling module may also insert PMARK instructions into destination instruction blocks. For example, as illustrated in FIG. 5, instruction block 115 and 120 may be possible destination instructions blocks from instruction block 110. The profiling module may insert the PMARK1 instruction into instruction block 115 and the PMARK2 instruction into instruction block 120,

When a processing module executes the instructions of e application 100, the profile instructions may cause the processing module to generate a path identifier for an execution path executed by the processing module. As discussed above, an execution path may be a sequence of instructions and/or instruction blocks executed by the processing module. The path identifier may include data indicative of the instruction blocks executed by the processing module. For example, an execution path may start at instruction block 105, proceed to instruction block 110, proceed to instruction block 120, proceed to instruction block 135, proceed to instruction block 140, proceed to instruction block 145, and proceed to instruction block 150. When the processing module executes the PSTART instruction in instruction block 105, the processing module may begin generating a path identifier. For example, as discussed below in conjunction with FIG. 9, the processing module may add an identifier (e.g., a program counter, an address, and/or a location) for a first instruction (e.g., a starting instruction) in the instruction block 105, to a path identifier that is stored in a memory module (e.g., a register, a cache, and/or any device or component that may store data). When a PMARK instruction is executed, the processing module may update the path identifier to indicate that the instruction block that contained the PMARK instruction was executed. For example, as the processing module executes instruction block 120, the processing module may execute the PMARK2 instruction. The PMARK2 instruction may cause the processing module to update a path signature to indicate that instruction block 120 was executed. When the processing module executes the P-END instruction, the processing module may indicate to a path identifier module (discussed below in conjunction with FIGS. 7 and 9) that the end of the region of instructions to profile has been reached. The path identifier module may determine how to process the path identifier and whether to add the path identifier to existing path identifier data.

FIG. 6 is a table 290 illustrating example path identifier data, according to one embodiment of the disclosure. As discussed above, a processing module may generate path identifiers when the processing module executes profiling instructions. A path identifier module may store path identifier data that includes a plurality of path identifiers and information associated with each of the path identifiers, such as the number of times an execution path associated with a path identifier occurs. The path identifier data may be stored in a memory module (e.g., a register, a random access memory, a cache, etc.). Although the path identifier data is illustrated in the form of a table (e.g., table 290), it should be understood that the path identifier data may be represented using various other data structures and/or representations. For example, the path identifier data may be represented using a graph, a tree, a list, etc. In other embodiments, the table 290 may include any number of entries. For example, the table 290 may include four entries, eight entries, 16 entries, thirty-two entries, sixty four entries, etc.

The table 290 includes five columns. The first column is labeled “Instruction Identifier” and includes identifiers for the starting and/or beginning instruction (e.g., the program counter for the first instruction) in an execution path. It should be understood that in other embodiments, the instruction identifier may be a number, alpha-numeric value, string, hex value, binary value, and/or any other value that may be used to identify an the starting and/or beginning instructions in the execution path. The second column is labeled “Path Signature” and includes data and/or values that may be used to identify instruction blocks in the execution path that were executed by the processing module, In one embodiment, the path signature may be a bit string (e.g., a sequence of bit values). For example, the path signature may be a 16-bit value, or a 32-bit value, or a 64-bit value, etc. It should be understood that in other embodiments, the path signature may be a number, alpha-numeric value, string, hex value, binary value, and/or any other value that may be used to identify an execution path. The instruction identifier and the path signature for an entry may form a path identifier for the entry. In one embodiment, the path identifier may be used to identify an execution path by identifying the first instruction in the execution path, and the instruction blocks (after the first instruction) that were executed by the processing device.

The third column is labeled “Counter” and includes values and/or data indicating the number of times an execution path (identified by the instruction identifier and path signature) has been executed by the processing module. For example, the first entry has a counter value of “2” indicating that the execution path identified by the path identifier (e.g., the instruction identifier and the path signature) for the first entry has been executed twice by a processing module, In one embodiment, the counter value may be incremented by a value (e.g., 1) each time an execution path is executed by the processing module. It should be understood that in other embodiments, the counter may be a number, alpha-numeric value, string, hex value, binary value, and/or any other value that may be used represent the number of times an execution path has been executing by the processing module. The fourth column is labeled “Saturated” and includes values and/or data that indicate whether a counter for an execution path has reached a maximum value (e.g., whether a counter is saturated). For example, the second entry has a saturated value of “1” indicating that the counter for the second entry has reached a maximum value (e.g., 16). In one embodiment, the saturated value may be a one-bit value. This may allow the path identifier module to determine whether a counter is saturated more quickly, For example, the counter for a path identifier may be a 15-bit value. The path identifier module may take longer to compare the counter with a maximum counter value, then checking the one-bite saturated value, to determine whether the counter has reached a maximum value. It should be understood that in other embodiments, the saturated value may be a number, alpha-numeric value, string, hex value, binary value, and/or any other value. In one embodiment, the fourth column may be optional because the path identifier module may compare the counter value with a maximum counter value to determine whether a counter is saturated.

The fifth column is a labeled “Valid” and includes values and/or data indicating whether an entry (e.g., a row) in the table 290 is valid. For example, the valid value may indicate whether an entry is still used, whether an entry can be removed from the table 290, and/or whether an entry can be overwritten in the table 290. In one embodiment, the value may be a one-bit value. It should be understood that in other embodiments, the valid value may be a number, alpha-numeric value, string, hex value, binary value, and/or any other value to indicate whether an entry is still valid. In one embodiment, the path identifier module (discussed below in conjunction with FIG. 9) may overwrite entries (e.g., rows) in the table 290 when the table 290 no longer has free entries. The path identifier module may use entries that are not marked valid. For example, the valid value for the third entry is “0” indicating that that the entry is no longer valid and can be overwritten.

Each entry (e.g., row) of the table 290 includes a path identifier and associated information for an execution path. In one embodiment, the path identifier includes the instruction identifier and the path signature for the execution path. For example, the fourth row includes a path identifier that includes the instruction identifier “65381452” and the path signature “1001.” The path identifier for the fourth row may be “65381452/1001.” Referring back to FIG. 5, the instruction identifier “65381452” may be the program counter (e.g., an address) for the first instruction in the instruction bock 105. As discussed above, the path signature includes data and/or values that, may be used to identity instruction blocks in the execution path that were executed by the processing device. Referring back to FIG. 5, the path signature for the fourth entry includes four bit values, the first bit value indicating whether instruction block 115 was executed, the second bit value indicating whether instruction block 120 was executed, the third bit value indicating whether instruction block 135 was executed, and the fourth bit value indicating whether instruction block 140 was executed. As shown in FIG. 6, the bit value “1001” indicates that the instruction block 115 was executed, instruction block 120 was not executed, instruction block 135 was not executed, and instruction block 140 was executed. In another example, the fifth row includes a path identifier that includes the instruction identifier “65381452” and the path signature “1010.” Referring back to FIG, 5, the instruction identifier “65381452” may be the program counter for the first instruction in the instruction bock 105. The path signature for the fourth entry includes lour bit values, the first bit value indicating whether instruction block 115 was executed, the second bit value indicating whether instruction block 120 was executed, the third bit value indicating whether instruction block 135 was executed, and the fourth bit value indicating whether instruction block 140 was executed. As shown in FIG. 6, the bit value “1010” indicates that the instruction block 115 was executed, instruction block 120 was not executed, instruction block 135 was executed, and instruction block 140 was not executed. Although the fourth and fifth entries show in the example table 290 include the same instruction identifier, the path signatures for the fourth and fifth entries are different. Thus, the path identifier (e.g., the combination of the instruction identifier and the path signature) for the fourth entry is different from the path identifier for the fifth entry.

In one embodiment, the data and/or information in the table 290 (e.g., the path identifiers, the counters, etc.) may be used by the profiling module to generate a path profile (as discussed further below in conjunction with FIGS. 7 and 8). The profiling module may also update one or more of the counter value, the saturated value, and/or the valid value for an entry in the table 290 (as discussed further below in conjunction with FIGS. 7 and 8).

FIG. 7 is a block diagram of a system architecture 300 for generating a path profile, according to one embodiment of the disclosure. The system architecture includes a compiler 310, application 100 (as illustrated in FIG. 5), a profiling module 330, a path identifier module 340, a processing module 350, and a memory module 360.

Memory module 360 may include random access memory (RAM) or read-only memory (ROM) in a fixed or removable format. RAM may include memory to hold information during the operation of the processing module 350 such as, for example, static RAM (SRAM) or dynamic RAM (DRAM). ROM may include memories such as computing device BIOS memory to provide instructions when a computing device activates, programmable memories such as electronic programmable ROMs (EPROMs), Flash, etc. Other fixed and/or removable memory may include magnetic memories such as floppy disks, hard drives, etc., electronic memories such as solid state Flash memory (e.g., eMMC, etc.), removable memory cards or sticks (E.g., USB, micro-SD, etc.), optical memories such as compact disc-based ROM (CD-ROM), holographic, etc.

As discussed above, the application 100 may be a program, a software module, a software component, and/or other software element that may be executing by the processing module 350. The application 100 may include a plurality of instructions to cause processing module 350 to perform activities such as, but not limited to, reading data, writing data, processing data, formulating data, converting data, transforming data, etc. The instructions in the application 100 may be divided into blocks of instructions (e.g., a series or group of instructions), such as instruction blocks 105 through 150. In one embodiment, the instruction blocks 105 through 150 may be basic blocks. A basic block may be a group (e.g., a block) of instructions that has one entry point (e.g., one instruction in the basic block is the destination of a JUMP and/or BRANCH instruction) and one exit point (e.g., the last instruction may be a JUMP or a BRANCH instruction to a different basic block).

Processing module 350 may execute instructions of the application 100. Instructions may include program code to cause processing module 350 to perform activities such as, but not limited to, reading data, writing data, processing data, formulating data, converting data, transforming data, etc. The processing module 350, as one illustrative example, may include a complex instruction set computer (CISC) microprocessor, a reduced instruction set computing (RISC) microprocessor, a very long instruction word (VLIW) microprocessor, a multi-core. processor, a multithreaded processor, an ultra low voltage processor, an embedded processor, a processor implementing a combination 01 instruction sets, and/or any other processor device, such as a digital signal processor, for example. The processing module 350 may be a general-purpose processor, such as a Core™ i3, i5, i7, 2 Duo and Quad, Xeon™, Itaniumm™, XScale™ or StrongARM™ processor, which are available from Intel Corporation, of Santa Clara, Calif. Alternatively, the processing module 350 may be from another company, such as ARM Holdings, Ltd, MIPS, etc. The processing module 350 may be a special-purpose processor, such as, for example, a network or communication processor, compression engine, graphics processor, co-processor, embedded processor, an application specific integrated circuit (ASIC), a field programmable gate array (FPGA), a digital signal processor (DSP), or the like. The processing module 350 may be implemented on one or more chips. The processing module 350 may be a part of and/or may be implemented on one or more substrates using any of a number of process technologies, such as, for example, BiCMOS, CMOS, or NMOS.

In one embodiment, the compiler 310 may generate the application 100 based on source code. Source code may be one or more computer instructions written using some human-readable language (e.g., a programming language, such as JAVA, C++, C, C#, etc.). The compiler 310 may be any processing logic that may comprise hardware (e.g., circuitry, dedicated. logic, programmable logic, microcode, etc.), software (such as instructions run on a processing device), firmware, or a combination thereof, that may generate instructions (e.g., binary code, object code, program instructions, etc.) that can, with or without additional linkage processing, be executed by the processing module 350. In another embodiment, the compiler 310 may be a just-in-time (JIT) compiler. A JIT compiler may be a compiler that generates bytecode from source code. The bytecode may be an intermediate representation that is translated and/or interpreted by a virtual machine into instructions (e.g., binary code, object code, program instructions, etc.) that may be executed by processing module 350. The bytecode generated by a JIT compiler may be portable among different computer architectures. A virtual machine associated with each of the different computer architectures may translate and/or interpret the bytecode into instructions used by the computer architecture.

In one embodiment, the profiling module 330 may analyze the application 100 and may identify a region of instructions that should be profiled (e.g., identify a region of instructions to generate a path profile for). The profiling module 330 may receive user input indicating the region of instructions to profile. The profiling module 330 may also analyze the application 100 to determine which region of instructions in the application should be profiled. In one embodiment, the profiling module 330 may apply heuristics, parameters, conditions, and/or rules, to determine whether a region of instructions should be profiled. For example, the profiling module 330 may determine that for a hardware/software co-designed machine, some translated regions of code and/or specific portions inside the translated regions of code should be profiled.

The profiling module 330 may also insert and/or add profiling instructions (e.g., the PSTART, P-END, and PMARK instructions illustrated in FIG. 5). As discussed above in conjunction with FIG. 5, the profiling instructions may generate a path identifier (e.g., generate. an instruction identifier and/or a path signature) for an execution path when the processing module 350 executes the profiling instructions. For example, after identifying a region of instructions to profile, the profiling module 330 may add a PSTART instruction (e.g., a start instruction) to the first instruction block in the region., The profiling module 330 may also add a P-END instruction (e.g., an end instruction) to each instruction block that branches and/or transitions out of the region (e.g., add a P-END instruction to each ending instruction block for the region). The profiling module 330 may also add a PMARK instruction to each instruction block that is a destination (e.g., a target) of a branch and/or jump instructions (e.g., a destination instruction block) inside the region.

In one embodiment, the profiling instructions may be instructions that are part of an instruction set architecture (ISA) for the processing module 350, An ISA may include the native data types, instructions, registers, addressing modes, memory architecture, interrupt and exception handling, and external input/output interfaces used by a processing module. An ISA may also include listing of operation codes (e.g., opcodes) and native commands implemented by a particular processing module. In one embodiment, the ISA may be a public ISA (e.g., an ISA that is exposed to applications and/or software that execute on the processing module. In another embodiment, the ISA may be a private ISA (e.g., an ISA that is not exposed to the applications and/or software that executes on the processing module). For example, the host ISA for a hardware/software co-designed machine may be a private ISA. When a private ISA is used, the applications may be compiled to a public ISA (e.g., an x86 ISA). The hardware (e.g., a processor) and/or a software layer inside the processor dynamically translates the instructions in the public ISA into a private ISA that executes in the hardware. In one embodiment, the private ISA instructions may run more efficiently in the hardware and the underlying hardware implementation may not be tied to the public ISA. In one embodiment, an ISA may already implement existing instructions that may be used to mark the beginning and end of a region of instructions. The PSTART (e.g., start instruction) and P-ENI) instructions may extend the functionality of the existing instructions to work in conjunction with the path identifier module 340 to generate path identifiers.

In another embodiment, the profiling module 330 may enable and disable profiling by indicating to the path identifier module 340 whether the path identifier module 340 should update path identifier data 345 (e.g., table 290 as illustrated in FIG. 6). For example, even though a region of instructions may include profiling instructions, the path identifier module 340 may determine that the region of code should not be profiled (e.g., no path profile should be generated for that region of code). The profiling module 330 may set an enable bit and/or an enable line of the path identifier module 340 to a value of “0” to indicate that the path identifier module should not store and/or process path identifiers generated by the profiling instructions.

In one embodiment, the profiling module 330 may periodically update and/or modify the path identifier data 345 (e.g., update the contents of the table 290). For example, referring to FIG. 6, the profiling module 330 may reset a counter for an entry in the table 290 (that has reached the maximum counter value) to “0” and may set the saturated value to “0” to indicate that the counter is no longer saturated. In another example, the profiling module 330 may determine that an entry is no longer used and/or useful and may set the valid value in the table 290 to “0” to indicate that the entry can be deleted and/or overwritten. In another embodiment, the profiling module 330 may also copy the path identifier data 345 to the memory module 360. This may allow the profiling module 330 to reset one or more values in the path identifier data (e.g., reset counter values and/or saturated values) but still track the data that was originally in the path identifier data 345. For example, copying an entry in the path identifier data 345 into the memory module 360 may allow the profiling module 330 to track the total number of times an execution path associated with the entry was executed even though the profiling module 330 may reset the counter value for the entry to allow the path identifier module 340 to continue incrementing the counter value.

In one embodiment, the profiling module 330 may generate a path profile based on the path identifier data 345 and/or data in the memory module 360 (e.g., entries that are copied into the memory module 360). The path profile may include data and/or information about the execution of the instructions of application 100. The path profile may include data such as the locations of BRANCH and/or JUMP instructions, the number of times each path of a BRANCH instruction is taken, the memory locations (e.g., registers) used and/or accessed by instructions, types of instructions, etc. In one embodiment, the path profile may be data that indicates how instructions of the application 100 were executed and/or resources (e.g., memory registers, circuits and/or components of the processing module 350) that are used by the instructions of the application 100. The path profile may also include data indicating the amount of time for a processing module 350 to execute an instruction and/or perform an action or operation. In one embodiment, the path profile may also include data indicative of one or more execution paths (e.g., sequences and/or paths of instruction blocks) executed by the processing module and the number of times the execution paths were executed by the processing module.

In one embodiment, the profiling module 330 may communicate (e.g., transmit data to and/or receive data from) with the compiler 310 when inserting profiling instructions. For example, profiling module 330 may insert profiling instructions as the compiler 310 compiles source code to generate the instructions for the application 100. In another embodiment, the profiling module 330 may be included as a component of and/or as part of the compiler 310. For example, the profiling module 330 may be a software modules and/or component used by the compiler 310 when the compiler 310 generates the instructions for the application 100. In one embodiment, the profiling module 330 may be processing logic that may comprise software (such as instructions run on a processing device), hardware (e.g., circuitry, dedicated programmable logic, microcode, etc.), firmware, or a combination thereof. In one embodiment, the profiling module 330 may be part of the compiler 310.

In one embodiment, the path identifier module 340 may manage, update, and/or modify the path identifier data 345 (e.g., table 290 illustrated in FIG. 6). For example, the path identifier module 340 may insert a new path identifier into the path identifier data 345 and update counter values for the new path identifier. The path identifier module 340 may receive a request and/or data from the profiling module 330 indicating that the path identifier module 340 should track and/or manage path identifiers and counters for the path identifiers. For example, the profiling module 330 may set an enable bit in the path identifier module 340 to “1” indicating that the path identifier module 340 should track and/or manage path identifiers (e.g., that profiling is enabled).

The path identifier module 340 is communicatively coupled to the processing module 350. In one embodiment, as the processing module 350 executes profiling instructions, the profiling instructions may generate a path identifier, When the processing module 350 executes a P-END instruction, the path identifier module 340 may check whether the instruction identifier in the path identifier is within a certain range (e.g., whether a program counter is within a certain range) and may check whether profiling is enabled. If the instruction identifier is within the range and profiling is enabled, the path identifier module 340 may determine whether there is an existing entry for the path identifier. If there is no existing entry, the path identifier module 340 determines whether there is any space in the path identifier data 345 (e.g., whether there is any space in the table 290). If there is no more space, the path identifier module 340 may take no further action with the path identifier. If there is free space, the path identifier module 340 will add the path identifier to the path identifier data.

If there is an existing entry, the path identifier module 340 may determine whether counter associated with the entry is saturated (e.g., whether the counter has reached a maximum value). If the counter is saturated, the path identifier module 340 may take no further action with the path identifier. If not counter is not saturated, the path identifier module 340 may increment the counter. After incrementing the counter, the path identifier module 340 may determine whether the counter has reached a maximum value after being incremented. If the counter reached the maximum value, the path identifier module 340 may update a saturated value in the entry to indicate that the counter has reached the maximum value.

FIG. 8 is a block diagram illustrating a profiling module 330 for generating a path profile, according to an embodiment of the disclosure. The profiling module 330 includes an instruction module 405, a profiling tool, and a path identifier data tool 415. In one embodiment, the profiling module 330 may be processing logic comprising software (such as instructions run on a processing device). In another embodiment, the profiling module 330 may be processing logic that may comprise hardware (e.g., circuitry, dedicated logic, programmable logic, microcode, etc.), software, firmware, or a combination thereof. More or less components may be included in the profiling module 330 without loss of generality. For example, two of the modules may be combined into a single module, or one of the modules may be divided into two or more modules, The profiling module 305 may be coupled to a memory module 360. The memory module 360 may include RAM, ROM), electronic programmable ROMs (EPROMs), magnetic memories such as floppy disks, hard drives, etc., electronic memories such as solid state Hash memory (e.g., eMMC, etc.), removable memory cards or sticks (E.g., USB, micro-SD, etc.), optical memories such as compact disc-based ROM (CD-ROM), holographic, and/or any component that can store data and/or information.

In one embodiment, the instruction nodule 405 may insert, and/or add profiling instructions (e.g., the PSTART, P-END, and PMARK instructions illustrated in FIG. 5 As discussed above in conjunction with FIG, 5, the profiling instructions may generate a path identifier (e.g., generate an instruction identifier and/or a path signature) for an execution path when the processing module 330 executes the profiling instructions. The instruction module 405 may insert a PSTART instruction (e.g., a start instruction) at the beginning of a region of instructions at a starting instruction block that is in the front and/or top of the region of instructions), a P-END instruction (e.g., an end instruction) in each instruction block that branches and/or jumps out of the region of instructions (e.g., in each ending instruction block), and a PMARK instruction for each instruction block that is a destination of a BRANCH and/or JUMP instruction inside the region of instructions.

In one embodiment, the profiling tool 41( )may analyze the application 100 and may identify a region of instructions that should be profiled (e.g., identify a region of instructions to generate a path profile for). For example, the profiling tool 410 may identify the region of instructions where profiling instructions should be inserted and/or added. In another example, the profiling tool 410 may identifier ranges of instruction identifiers (e.g., ranges of program counter values and/or memory addresses) to indicate which instructions and/or instruction blocks should be profiled. In another embodiment, the profiling tool 410 may enable and disable profiling by indicating to a path identifier module (e.g., as illustrated in FIG. 7) whether the path identifier module should track path identifiers. For example, the profiling tool 410 may set an enable bit in the path identifier module to “1” to indicate that path identifiers should be tracked and/or managed. In one embodiment, the profiling tool 410 may also generate a path profile based on path identifier data and/or data in the memory module. For example, the profiling tool 410 may process the path identifiers and/or counters associated with the path identifiers to generate a path profile indicating the execution paths executed by the processing device and the frequency that the execution paths were executed by the processing device.

In one embodiment, the path identifier data tool 415 may periodically update and/or modify the path identifier data (e.g., path identifiers, counters associated with path identifiers, etc.). For example, the path identifier data tool 415 may periodically update and/or change a counter value associated with a path identifier or a saturated value associated with a path identifier. In another embodiment, the profiling module 330 may also copy the path identifier data 345 to the memory module 360. For example, as discussed above, the profiling module 330 may copy path identifiers and their associated counter values to the memory module 360. The path identifier data tool 415 may reset the counters for the path identifiers and allow the path identifier module to continue tracking the path identifiers.

FIG. 9 is a block diagram illustrating a path identifier module 340 for tracking execution paths, according to an embodiment of the disclosure. The path identifier module includes a path ID register 510, a filtering block 520, and a profiling block 530. In one embodiment, the path identifier module 340 may be processing logic that may comprise hardware (e.g., circuitry, dedicated logic, programmable logic, microcode, memory, etc.). In another embodiment, the profiling module 330 may be processing logic comprising hardware, software (such as instructions run on a processing device), software, firmware, or a combination thereof. More or less components may be included in the path identifier module 340 without loss of generality. For example, two of the modules may be combined into a single module, or one of the modules may be divided into two or more modules. The path identifier module 340 may be coupled to a memory module 360. The memory module 360 may include RAM, ROM), electronic programmable ROMs (EPROMs), magnetic memories such as floppy disks, hard drives, etc., electronic memories such as solid state Flash memory (e.g., eMMC, etc.), removable memory cards or sticks (E.g. USB, micro-SD, etc.), optical memories such as compact, disc-based ROM (CD-ROM), holographic, and/or any component that can store data and/or information.

In one embodiment, the path ID register 510 may be a temporary memory location that stores a path identifier that includes a path signature 511 and an instruction identifier 512. In another embodiment, the path ID register 510 may be a dedicated register inside the processing module or inside an execution core of the processing module. The path ID register 510 may be initialized when a processing module executes a PSTART instruction (e.g., a profiling instruction). The PSTART instruction may cause the processing module to update the instruction identifier 512 with the address and/or location (e.g., a program counter and/or a memory address) of the starting instruction in the instruction block that contains the PSTART instruction. In another embodiment, as the processing module executes instructions and/or instruction blocks, the PMARK instructions may update the path signature 511 to indicate which instruction blocks were executed by the processing module. For example, as discussed above with reference to FIGS. 5 and 6, when the processing device executes instruction bock 115 and 135, the PMARK instructions (e.g., PMARK1 and PMARK3) may generate the path signature “1010,” in one embodiment, when the processing module executes the P-END instruction, the P-END instruction may cause the path end indicator 513 to be set to a value (e.g., “1” or “true”) indicating that the end of the region of instructions to be profiled has been reached.

In one embodiment, the filtering Nock 520 may determine whether to provide a path identifier to the profiling block 530. As discussed, the processing module may generate a path identifier (that is stored in the path ID register 510) when the processing module executes profiling instructions. The filtering block 520 includes a range module 522 that determines whether the instruction identifier 512 is within a range of instruction identifiers. For example, the range module 522 may determine whether the instruction identifier 512 is within a range of program counters. The range module 522 may provide the result of the determination of the range to the AND gate 523. The filtering block 520 also includes an enable bit 521. The enable bit 521 may be set by a profiling module to indicate whether profiling should be performed (e.g., to indicate whether a path profile should be generated, The enable bit 521 is also provided to the AND gate 523. As discussed above, the path end indicator 513 may be set when the processing device executes a P-END instruction. In one embodiment, when the enable bit 521 is set to a value indicating that profiling should be performed (e.g., “true” or “1”), the range module 522 determines that the instruction identifier 512 is within a range of instruction identifiers, and the path end indicator 513 is set to a value indicating that the end of the region of instructions to be profiled has been reached. the AND gate 523 may send a signal STORE_PATH_ID to the profiling block 530. The signal STORE_PATH_ID may indicate to the profiling block 530 that the profiling block 530 should attempt to store the path identifier in the path register 510. In other embodiments, the signal STORE_PATH_ID may be any value, data, information, and/or message indicating that the profiling block 520 should store the path identifier in the path ID register 510.

In one embodiment, the profiling block 530 may manage, update, and/or modify the path identifier data 345 (e.g., table 290 illustrated in FIG. 6). The profiling block 530 may determine whether there is an existing entry for the path identifier received from the path ID register 510. If there is no existing entry, the profiling block 530 determines whether there is any space in the path identifier data 345 (e.g., whether there is an space in the table 290). For example, the profiling block 530 may determine whether there are unused entries or entries that may be overwritten (e.g., entries that have a valid value set to “0”). If there is no more space, the profiling block 530 may take no further action with the path identifier, If there is free space, the profiling block 530 will add the path identifier to the path identifier data 345 (e.g., add a new entry to the table 290 or overwrite an existing entry in the table 290).

If there is an existing entry, the profiling block 530 may determine whether counter associated with the entry is saturated. If the counter is saturated, the profiling block 530 may take no further action with the path identifier. If not counter is not saturated, the profiling block 530 may increment the counter and may determine whether the counter has reached a maximum value after being incremented, If the counter reached the maximum value, the profiling block 530 may update a saturated value in the entry to indicate that the counter has reached the maximum value. In another embodiment, the profiling block 530 may also copy the path identifier data 345 to the memory module 360. For example, as discussed above, the profiling block 530 may copy path identifiers and their associated counter values to the memory module. 360. The profiling block 530 may reset the counters for the path identifiers and allow the profiling block 530 to continue tracking the path identifiers.

FIGS. 10-11 are flow diagrams illustrating methods for generating a path profile. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media. In one embodiment, the methods may be performed by a server machine (e.g., a server computer). Alternatively, the methods may be performed by a combination of a server machine and a client machine. For example, the operations of the methods may be divided between a client and server machine.

FIG. 10 is a flow diagram illustrating a method 600 generating a path profile, according to one embodiment of the disclosure. Method 600 may be performed by processing logic that may comprise hardware (e.g., circuitry, dedicated logic, programmable logic, microcode, etc,), software (such as instructions run on a processing device), firmware, or a combination thereof. In one embodiment, method 600 may be performed a profiling module, as illustrated in FIGS. 7 and 8.

Referring to FIG. 10, the method 600 begins at block 605 where the method 600 identifies a region of instructions to profile. In one embodiment, the method 600 may identifier multiple regions of instructions to profile. The region and/or regions of instructions may be identified based on user input and/or heuristics, conditions and/or rules. At block 610, the method 600 may identify a starting instruction block, one or more ending instruction blocks, and one or more destination instruction blocks. The method 600 may insert profiling instructions at block 615. For example, the method 600 may insert a starting instruction (e.g., PSTART) in the starting instruction block, an ending instruction (e.g., P-END) in the ending instruction blocks, and marking instructions (e.g., PMARK) in destination instruction blocks. At block 620, the method 600 may receive a plurality of path identifiers. For example, the method 600 may request the plurality of path identifiers from a path identifier module and the path identifier module may provide the plurality of path identifiers. Optionally, at block 625, the method 600 may provide data indicating a one or more path identifiers to the path identifier module. The path identifier module may update counters and/or saturated values for the one or more path identifiers, The method 600 may copy the plurality of path identifiers to a memory (e.g., memory module 360 illustrated in FIG. 7) at block 630. For example, the method 600 may send data indicating that the plurality of path identifiers should be copied to a memory module, to a path identifier module. The path identifier module may copy the path identifiers to the memory module and/or provide the path identifiers to the profiling module so that the profiling module may copy the path identifiers to the memory module. At block 635, the method 600 may generate a path profile based on the path identifiers stored in the path identifier module and/or the path identifiers copied to the memory.

FIG. 11 is a flow diagram illustrating a method of tracking execution paths, according to one embodiment of the disclosure. Method 700 may be performed by processing logic that may comprise hardware (e.g., circuitry, dedicated logic, programmable logic, microcode, etc.), software (such as instructions run on a processing device), firmware, or a combination thereof. In one embodiment, method 700 may be performed a path identifier module, as illustrated in FIGS. 7 and 9.

Referring to FIG. 11, the method 700 begins at block 705 where the method 700 receives a path identifier. In one embodiment, the path identifier may be generated when a processing module executes profiling instructions (e.g., PSTART, P-END, PMARK, etc.) inserted into instruction blocks. At block 710, the method 700 determines whether the path identifier already exists in path identifier data (e.g., table 290 illustrated in FIG. 6) stored in the path identifier module. If an entry with the path identifier exists in the path identifier data, the path identifier module determines whether the entry is saturated (e.g., whether the counter for the entry has reached a maximum value). If the entry is not saturated, the method 700 proceeds to block 720 where the method 700 updates the counter for the entry. The method then updates the saturated value if the increment counter reaches the maximum value (block 725). If the entry is not saturated, the method 700 proceeds to block 745.

If no entry with the path identifier exists in the path identifier data, the method 700 proceeds to block 730, where the path identifier module determines whether there are free entries (e.g., free space) within the path identifier data, For example, the method 700 may determine whether there are unused entries and/or entries that can be overwritten (e.g., by checking the valid bit). If there are free entries, the method 700 creates an entry for the path identifier (block 735). At block 740, the method initializes the other values for the entries. For example, the method 700 may set the counter for the entry to “1” (to indicate that the execution path identified by the path identifier has been executed once), the valid bit to “1” (to indicate that the entry is still valid), and the saturated value to “0” (to indicate that the entry is not saturated). If there are no free entries the method 700 proceeds to block 745.

At block 745, the method 700 may optionally receive data indicating one or more path identifiers. For example, the method 700 my receive data indicating one or more path identifiers from a profiling module. At block 750, the method 700 may update counter values for the one or more path identifiers, update saturated values for the one or more path identifiers, and/or copy the one or more path identifiers and their associated counter values) to a memory module (e.g., memory module 360 illustrated in FIG. 7).

FIG. 12 is a block diagram of a SoC 800 in accordance with an embodiment of the present disclosure. Dashed lined boxes are optional features on more advanced SoCs. In FIG. 8, an interconnect unit(s) 812 is coupled to: an application processor 820 which includes a set of one or more cores 802A-N and shared cache unit(s) 806; a system agent unit 810; a bus controller unit(s) 816; an integrated memory controller unit(s) 814; a set or one or more media processors 818 which may include integrated graphics logic 808, an image processor 824 for providing still and/or video camera functionality, an audio processor 826 for providing hardware audio acceleration, and a video processor 828 for providing video encode/decode acceleration; an static random access memory (SRAM) unit 830; a direct memory access (DMA) unit 832; and a display unit 840 for coupling to one or more external displays.

The memory hierarchy includes one or more levels of cache within the cores, a set or one or more shared cache units 806, and external memory (not shown) coupled to the set of integrated memory controller units 814. The set of shared cache units 806 may include one or more mid-level caches, such as level 2 (L2), level 3 (L3), level 4 (L4), or other levels of cache, a last level cache (LLC), and/or combinations thereof.

In some embodiments, one or more of the cores 802A-N are capable of multi-threading.

The system agent unit 810 includes those components coordinating and operating cores 802A-N. The system agent unit 810 may include for example a power control unit (PCU) and a display unit. The PCU may be or include logic and components needed for regulating the power state of the cores 802A-N and the integrated graphics logic 808. The display unit is for driving one or more externally connected displays.

The cores 802.A-N may be homogenous or heterogeneous in terms of architecture and/or instruction set. For example, some of the cores 802A-N may be in order while others are out-of-order. As another example, two or more of the cores 802A-N may be capable of execution the same instruction set, while others may be capable of executing only a subset of that instruction set or a different instruction set.

The application processor 820 may be a general-purpose processor, such as a Core™ i3, i5, i7, 2 Duo and Quad, Xeon™, Itanium™, XScale™ or StrongARM™ processor, which are available from Intel Corporation, of Santa Clara, Calif. Alternatively, the application processor 820 may be from another company, such as ARM Holdings, Ltd, MIPS, etc. The application processor 820 may be a special-purpose processor, such as, for example, a network or communication processor, compression engine, graphics processor, co-processor, embedded processor, or the like. The application processor 820 may be implemented on one or more chips. The application processor 820 may be a part, of and/or may be implemented on one or more substrates using any of a number of process technologies, such as, for example, BiCMOS, CMOS, or NMS.

FIG. 13 is a block diagram of an embodiment of a system on-chip (SOC) design in accordance with the present disclosure. As a specific illustrative example, SOC 900 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 900 includes 2 cores—906 and 907. Cores 906 and 907 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 906 and 907 are coupled to cache control 909 that is associated with bus interface unit 909 and L2 cache 910 to communicate with other parts of system 900. Interconnect 911 includes an on-chip interconnect, such as an IOSF, AMBA, or other interconnect discussed above, which potentially implements one or more aspects of the described disclosure.

Interconnect 911 provides communication channels to the other components, such as a Subscriber Identity Module (SIM) 930 to interface with a SIM card, a boot roan 935 to hold boot code for execution by cores 906 and 907 to initialize and boot SOC 900. a SDRAM controller 940 to interface with external memory (e.g. DRAM 960), a flash controller 945 to interface with non-volatile memory (e.g. Flash 965), a peripheral control 950 (e.g. Serial Peripheral Interface) to interface with peripherals, video codecs 920 and Video interface 925 to display and receive input (e.g. touch enabled input), GPU 915 to perform graphics related computations, etc. Any of these interfaces may incorporate aspects of the disclosure described herein.

In addition, the SOC 900 illustrates peripherals for communication, such as a Bluetooth module 970, 3G modem 975, GPS 980, and Wi-Fi 985. Note as stated above, a UE includes a radio for communication. As a result, these peripheral communication modules are not all required. However, in a LTE, some form a radio for external communication is to be included.

FIG. 14 illustrates a diagrammatic representation of a machine in the example form of a computer system 1000 within which a set of instructions, for causing the machine to perform any one or more of the methodologies discussed herein, may be executed. In alternative. embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1000 includes a processing device 1002, a main memory 1004 (e.g., read-only memory (ROM), flash memory, dynamic random access memory (DRAM; such as synchronous DRAM (SDRAM) or DRAM (RDRAM), etc.), a static memory 1006 (e.g., flash memory, static random access memory (SRAM), etc.), and a data storage device 1018, which communicate with each other via a bus 1030.

Processing device 1002 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In one embodiment, processing device 1002 may include one or processing cores. The processing device 1002 is configured to execute the instructions 1026 for performing the operations discussed herein.

The computer system 1000 may further include a network interface device 1008 communicably coupled to a network 1020. The computer system 1000 also may include a video display unit 1008 (e.g., a liquid crystal display (LCD) or a cathode ray tube (CRT)), an alphanumeric input device 1012 (e.g., a keyboard), a cursor control device 1014 (e.g., a mouse), a signal generation device 1016 (e.g., a speaker), or other peripheral devices, Furthermore, computer system 1000 may include a graphics processing unit 1022, a video processing unit 1028, and an audio processing unit 1032. In another embodiment, the computer system 1000 may include a chipset (not illustrated), which refers to a group of integrated circuits, or chips, that are designed to work with the processing device 1002 and controls communications between the processing device 1002 and external devices. For example, the chipset may be a set of chips on a motherboard that links the processing device 1002 to very high-speed devices, such as main memory 1004 and graphic controllers, as well as linking the processing device 1002 to lower-speed peripheral buses of peripherals, such as USB, PCI or ISA buses.

The data storage device 1018 may include a computer-readable storage medium 1024 on .h is stored instructions 1026 embodying any one or more of the methodologies of functions described herein. The instructions 1026 may also reside, completely or at least partially, within the main memory 1004 and/or within the processing device 1002 during execution thereof by the computer system 1000; the main memory 1004 and the processing device 1002 also constituting computer-readable storage media.

The computer-readable storage medium 1024 may also be used to store instructions 1026 utilizing the profiling module 330 and/or path identifier module 340, such as described with respect to FIGS. 7, 8, and 9 and/or a software library containing methods that call the above applications, While the computer-readable storage medium 1024 is shown in an example. embodiment to be a single medium, the term “computer-readable storage medium” should be taken to include a single medium or multiple media (e.g., a centralized or distributed database, and/or associated caches and servers) that store the one or more sets of instructions, The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

The following examples pertain to further embodiments.

Example 1 is an apparatus comprising a memory to store a plurality of path identifiers, wherein each path identifier in the plurality of path identifiers comprises data indicative of an execution path a path signature that identifies one or more instruction blocks, and an instruction identifier that identifies a first instruction in a first instruction block of the one or more instruction blocks, and a processor communicatively couple to the memory, The processor is configured to, receive a first path identifier, determine whether the first path identifier matches an existing path identifier in the plurality of path identifiers, increment a counter associated with the existing path identifier when the first path identifier matches the existing path identifier, and add the first path identifier to the plurality of path identifiers when the first path identifier does not match the existing path identifier in the plurality of path identifiers.

Example 2 may optionally extend the subject matter of example 1, In Example 2, the processor is further to configured to determine whether an instruction identifier is within a range of instruction identifiers.

Example 3 may optionally extend the subject matter of any one of examples 1-2. In example 3, the first path identifier is generated when the processor completes execution of the execution path.

Example 4 may optionally extend the subject matter of any one of examples 1-3. In example 3, the processor is further configured to execute a plurality of instructions, wherein the plurality of instructions comprises one or more profiling instructions that cause the processor to generate the first path identifier when the processor executes the one or more profiling instructions.

Example 5 may optionally extend the subject matter of any one of examples 1-4. In example 5, the processor increments the counter by determining whether the counter has reached a maximum value and when the counter has not reached the maximum value incrementing the counter, and updating a saturated value when the counter reaches the maximum value after incrementing the counter.

Example 6 may optionally extend the subject matter of any one of examples 1-5. In example 6, the processor adds the first path identifier to the plurality of path identifiers by determine whether there is space in the plurality of path identifiers to add the first path identifier, and add the first path identifier when there is space in the plurality of path identifiers.

Example 7 may optionally extend the subject matter of any one of examples 1-6, In example 7, the processor comprises the memory.

Example 8 may optionally extend the subject matter of any one of examples 1-7. In example 8, the first identifier is received from a register in the processor.

Example 9 may optionally extend the subject matter of any one of examples 1-8. In example 9, the processor is further configured to receive data indicative of one or more path identifiers, and remove the one or more path identifiers from the plurality of path identifiers based on the data.

Example 10 may optionally extend the subject matter of any one of examples 1-9. In example 10, the processor is further configured to receive data indicative of one or more path identifiers, and reset one or more counters or one or more saturated values for the one or more path identifiers based on the data.

Example 11 may optionally extend the subject matter of ands one of examples 1-10. In example 11, the processor is further configured receive data indicative of one or more path identifiers, and copy the one or more path identifiers to a second memory.

Example 12 is a method comprising receiving a first path identifier, determining whether the first path identifier matches an existing path identifier in a plurality of path identifiers, wherein each path identifier in the plurality of path identifiers comprises data indicative of an execution path, a path signature that identifies one or more instruction blocks, and an instruction identifier that identifies a first instruction in a first instruction block of the one or more instruction blocks, incrementing a counter associated with the existing path identifier when the first path identifier matches the existing path identifier, and adding the first path identifier to the plurality of path identifiers when the first path identifier does not match the existing path identifier in the plurality of path identifiers.

Example 13 may optionally extend the subject matter of example 12, In example 14, the method further comprises determining whether an instruction identifier is within a range of instruction identifiers.

Example 14 may optionally extend the subject matter of any one of examples 12-13. In example 14, the first path identifier is generated when a processor completes execution of the execution path.

Example 15 may optionally extend the subject matter of any one of examples 12-14. In example 15, the method further comprises executing a plurality of instructions, wherein the plurality of instructions comprises one or more profiling instructions that cause a processor to generate the first path identifier when the processor executes the one or more profiling instructions.

Example 16 may optionally extend the subject matter of any one of examples 1222-15. In example 16, incrementing the counter comprises determining whether the counter has reached a maximum value, and when the counter has not reached the maximum value incrementing the counter, and updating a saturated value when the counter reaches the maximum value after incrementing the counter.

Example 17 may optionally extend the subject matter of any one of examples 12-16. In example 17, adding the first path identifier to the plurality of path identifiers comprises determining whether there is space in the plurality of path identifiers to add the first path identifier, and adding the first path identifier when there is space in the plurality of path identifiers.

Example 18 may optionally extend the subject matter of any one of examples 12-17. In example 18, the first identifier is received from a register in a processor.

Example 19 may optionally extend the subject matter of any one of examples 1222-18. In example 19, the method further comprises receiving data indicative of one or more path identifiers, and removing the one or more path identifiers from the plurality of path identifiers based on the data.

Example 20 may optionally extend the subject matter of any one of examples 12-19. In example 20, the method further comprises receiving data indicative of one or more path identifiers, and resetting one or more counters or one or more saturated values for the one or more path identifiers based on the data.

Example 21 may optionally extend the subject matter of any one of examples 12-20. In example 21, the method further comprises receiving data indicative of one or more path identifiers, and copying the one or more path identifiers to a second memory.

Example 22 is a non-transitory machine-readable storage medium including data that, when accessed by a processor, cause the processor to perform operations comprising receiving a first path identifier, determining whether the first path identifier matches an existing path identifier in a plurality of path identifiers, wherein each path identifier in the plurality of path identifiers comprising data indicative of an execution path, a path signature that identifies one or more instruction blocks, and an instruction identifier that identifies a first instruction in a first instruction block of the one or more instruction blocks, incrementing a counter associated with the existing path identifier when the first path identifier matches the existing path identifier, and adding the first path identifier to the plurality of path identifiers when the first path identifier does not match the existing path identifier in the plurality of path identifiers.

Example 23 may optionally extend the subject matter of example 22. In Example 23, the operations further comprise determining whether an instruction identifier is within a range of instruction identifiers.

Example 24 may optionally extend the subject matter of any one of examples 24-23. In example 24, the first path identifier is generated when the processor completes execution of the execution path.

Example 25 may optionally extend the subject matter of any one of examples 22-24. In example 25, the operations further comprise executing a plurality of instructions, wherein the plurality of instructions comprises one or more profiling instructions that cause the processor to generate the first path identifier when the processor executes the one or more profiling instructions.

Example 26 may optionally extend the subject matter of any one of examples 24-25. In example 26, incrementing the counter comprises determining whether the counter has reached a maximum value, and when the counter has not reached the maximum value incrementing the counter, and updating a saturated value when the counter reaches the maximum value after incrementing the counter.

Example 27 may optionally extend the subject matter of any one of examples 22-26. In example 27, adding the first path identifier to the plurality of path identifiers comprises determining whether there is space in the plurality of path identifiers to add the first path identifier, and adding the first path identifier when there is space in the plurality of path identifiers.

Example 28 may optionally extend the subject matter of any one of examples 22-27, In example 28, the first identifier is received from a register in the processor. Example 29 may optionally extend the subject matter of any one of examples 22-28, In example 29, the operations further comprise receiving data indicative of one or more path identifiers, and removing the one or more path identifiers from the plurality of path identifiers based on the data.

Example 30 may optionally extend the subject matter of any one of examples 22-31. In example 30, the operations further comprise receiving data indicative of one or more path identifiers, and resetting one or more counters or one or more saturated values for the one or more path identifiers based on the data.

Example 31 may optionally extend the subject matter of any one of examples 22-30. In example 31, the operations further comprise receiving, data indicative of one or more path identifiers, and copying the one or more path identifiers to a second memory.

Example 32 is an apparatus comprising means for receiving a first path identifier, means for determining whether the first path identifier matches an existing path identifier in a plurality of path identifiers, wherein each path identifier the plurality of path identifiers comprises data indicative of an execution path, a path signature that identifies one or more instruction blocks, and an instruction identifier that identifies a first instruction in a first instruction block of the one or more instruction blocks, means for incrementing a counter associated with the existing, path identifier when the first path identifier matches the existing path identifier, and means for adding the first path identifier to the plurality of path identifiers when the first path identifier does not match the existing path identifier in the plurality of path identifiers,

Example 33 may optionally extend the subject matter of example 32. In Example 33, the apparatus is further configured to perform according to any one of claims 12 to 21.

Example 34 is a method comprising identifying of a region of instructions to profile, inserting profiling instructions into the region of instructions, receiving a plurality of path identifiers, wherein each path identifier in the plurality of path identifiers comprising data indicative of an execution path, a path signature that identifies one or more instruction blocks, and an instruction identifier that identifies a first instruction in a first instruction block of the one or more instruction blocks, and wherein the plurality of path identifiers is generated when a processor executes the profiling instructions, and generating a path profile based on the plurality of path identifiers.

Example 35 may optionally extend the subject matter of example 34. In Example 35, the method further comprises providing data indicating that one or more path identifiers, wherein one or more of counter values or saturated values associated with the one or more path identifiers are to be changed.

Example 36 may optionally extend the subject matter of any one of examples 34-35. In example 36, inserting the profiling instructions comprises identifying a plurality of destination instruction blocks in the region of instructions, and inserting marking instructions into the plurality of destination instruction blocks.

Example 37 may optionally extend the subject matter of any one of examples 34-36. In example 37, inserting the profiling instructions comprises identifying a starting instruction block and one or more ending instruction blocks in the region of instructions, and inserting a start instruction in the starting instruction block and one or more end instructions in the one or more ending instruction blocks.

Example 38 may optionally extend the subject matter of any one of examples 34-37. In example 38, the method further comprises copying the plurality of path identifiers to a memory.

Example 39 may optionally extend the subject matter of any one of examples 34-39. In example 39, the region of instructions to profile is identified based one or more of user input, heuristics associated with the region of instructions, or rules associated with the region of instructions.

Example 40 is an apparatus comprising a memory to store a plurality of path identifiers, wherein each path identifier in the plurality of path identifiers comprising data indicative of an execution path, a path signature that identifies one or more instruction blocks, and an instruction identifier that identifies a first instruction in a first instruction block of the one or more instruction blocks, and wherein the plurality of path identifiers is generated when a processor executes profiling instructions, a processor communicatively couple to the memory, the processor to identify of a region of instructions to profile, insert profiling instructions into the region of instructions, receive the plurality of path identifiers, and generate a path profile based on the plurality of path identifier.

Example 41 may optionally extend the subject matter of example 40. in Example 41, the processor is further configured to provide data indicating that one or more path identifiers, wherein one or more of counter values or saturated values associated with the one or more path identifiers are to be changed.

Example 42 may optionally extend the subject matter of any one of examples 40-41. In example 42, inserting the profiling instructions comprises identifying a plurality of destination instruction blocks in the region of instructions, and inserting marking instructions into the plurality of destination instruction blocks.

Example 43 may optionally extend the subject matter of any one of examples 40-42. In example 43, inserting the profiling instructions comprises identifying a starting instruction block and one or more ending instruction blocks in the region of instructions, and inserting a start instruction in the starting instruction block and one or more end instructions in the one or more ending instruction blocks,

Example 44 may optionally extend the subject matter of any one of examples 40-43. In example 44, the processor is further configured to copy the plurality of path identifiers to the memory.

Example 45 may optionally extend the subject matter of any one of examples 40-44. In example 45, the region of instructions to profile is identified based one or more of user input, heuristics associated with the region of instructions, or rules associated with the region of instructions.

Example 46 non-transitory machine-readable storage medium including data that, when accessed by a processor, cause the processor to perform a method according to any one of examples 34 to 39.

Example 47 is an apparatus comprising means for performing a method according to any one of examples 34 to 39.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware, or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “identifying,” “determining,” “performing” “incrementing.” “adding,” “executing,” “updating,” “removing,” “resetting,” “copying,” “inserting,” “generating,” “providing,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B. then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a. centralized or distributed database and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays is presented herein are not inherently related to any particular computer or other apparatus. Various general-purpose systems may be used with programs in accordance with the teachings herein, or it may prove convenient to construct a more specialized apparatus to perform the operations. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that, the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

1-25. (canceled)

26. An apparatus comprising:
a memory to store a plurality of path identifiers, wherein each path identifier in the plurality of path identifiers comprises data indicative of an execution path, a path signature that identifies one or more instruction blocks, and an instruction identifier that identifies a first instruction in a first instruction block of the one or more instruction blocks;
a processor communicatively coupled to the memory, the processor to:
receive a first path identifier;
determine whether the first path identifier matches an existing path identifier in the plurality of path identifiers;
increment a counter associated with the existing path identifier when the first path identifier matches the existing path identifier; and
add the first path identifier to the plurality of path identifiers when the first path identifier does not match the existing path identifier in the plurality of path identifiers.

27. The apparatus of claim 26, wherein the processor is further to:
determine whether an instruction identifier is within a range of instruction identifiers.

28. The apparatus of claim 26, wherein the first path identifier is generated when the processor completes execution of the execution path.

29. The apparatus of claim 26, wherein the processor is to increment the counter by:
determining whether the counter has reached a maximum value; and
when the counter has not reached the maximum value:
incrementing the counter; and
updating a saturated value when the counter reaches the maximum value after incrementing the counter.

30. The apparatus of claim 26, wherein the processor is to add the first path identifier to the plurality of path identifiers by:
determine whether there is space in the plurality of path identifiers to add the first path identifier; and
add the first path identifier when there is space in the plurality of path identifiers.

31. The apparatus of claim 26, wherein the processor comprises the memory.

32. The apparatus of claim 26, wherein the first identifier is received from a register in the processor.

33. The apparatus of claim 26, wherein the processor is further to:
receive data indicative of one or more path identifiers; and
remove the one or more path identifiers from the plurality of path identifiers based on the data.

34. The apparatus of claim 26, wherein the processor is further to:
receive data indicative of one or more path identifiers; and
reset one or more counters or one or more saturated values for the one or more path identifiers based on the data.

35. The apparatus of claim 26, wherein the processor is further to:
receive data indicative of one or more path identifiers; and
copy the one or more path identifiers to a second memory.

36. A method comprising:
receiving a first path identifier;
determining whether the first path identifier matches an existing path identifier in a plurality of path identifiers, wherein each path identifier in the plurality of path identifiers comprises data indicative of an execution path, a path signature that identifies one or more instruction blocks, and an instruction identifier that identifies a first instruction in a first instruction block of the one or more instruction blocks;
incrementing a counter associated with the existing path identifier when the first path identifier matches the existing path identifier; and
adding the first path identifier to the plurality of path identifiers when the first path identifier does not match the existing path identifier in the plurality of path identifiers.

37. The method of claim 36, wherein the method further comprises:
determining whether an instruction identifier is within a range of instruction identifiers.

38. The method of claim 36, wherein incrementing the counter comprises:
determining whether the counter has reached a maximum value; and
when the counter has not reached the maximum value:
incrementing the counter; and
updating a saturated value when the counter reaches the maximum value after incrementing the counter.

39. The method of claim 36, wherein adding the first path identifier to the plurality of path identifiers comprises:
determining whether there is space in the plurality of path identifiers to add the first path identifier; and
adding the first path identifier when there is space in the plurality of path identifiers.

40. The method of claim 36, wherein the method further comprises:
receiving data indicative of one or more path identifiers; and
performing one or more of:
copying the one or more path identifiers to a second memory;
removing the one or more path identifiers from the plurality of path identifiers based on the data; or
resetting one or more counters or one or more saturated values for the one or more path identifiers based on the data.

41. A non-transitory machine-readable storage medium including data that, when accessed by a processor, cause the processor to perform operations comprising:
receiving a first path identifier;
determining whether the first path identifier matches an existing path identifier in a plurality of path identifiers, wherein each path identifier in the plurality of path identifiers comprises data indicative of an execution path, a path signature that identifies one or more instruction blocks, and an instruction identifier that identifies a first instruction in a first instruction block of the one or more instruction blocks;
incrementing a counter associated with the existing path identifier when the first path identifier matches the existing path identifier; and
adding the first path identifier to the plurality of path identifiers when the first path identifier does not match the existing path identifier in the plurality of path identifiers.

42. The non-transitory machine-readable storage medium of claim 41, wherein the operations further comprise:
determining whether an instruction identifier is within a range of instruction identifiers.

43. The non-transitory machine-readable storage medium of claim 41, wherein incrementing the counter comprises:
determining whether the counter has reached a maximum value; and
when the counter has not reached the maximum value:
incrementing the counter; and
updating a saturated value when the counter reaches the maximum value after incrementing the counter.

44. The non-transitory machine-readable storage medium of claim 41, wherein adding the first path identifier to the plurality of path identifiers comprises
determining whether there is space in the plurality of path identifiers to add the first path identifier; and
adding the first path identifier when there is space in the plurality of path identifiers.

45. The non-transitory machine-readable storage medium of claim 41, wherein the operations further comprise:
receiving data indicative of one or more path identifiers; and
performing one or more of:
copying the one or more path identifiers to a second memory;
removing the one or more path identifiers from the plurality of path identifiers based on the data; or
resetting one or more counters or one or more saturated values for the one or more path identifiers based on the data.

46. A method comprising:
identifying of a region of instructions to profile;
inserting profiling instructions into the region of instructions;
receiving a plurality of path identifiers, wherein each path identifier in the plurality of path identifiers comprising data indicative of an execution path, a path signature that identifies one or more instruction blocks, and an instruction identifier that identifies a first instruction in a first instruction block of the one or more instruction blocks, and wherein the plurality of path identifiers is generated when a processor executes the profiling instructions; and
generating a path profile based on the plurality of path identifiers.

47. The method of claim 46, further comprising:
providing data indicating that one or more path identifiers, wherein one or more of counter values or saturated values associated with the one or more path identifiers are to be changed.

48. The method of claim 46, wherein inserting the profiling instructions comprises:
identifying a plurality of destination instruction blocks in the region of instructions; and
inserting marking instructions into the plurality of destination instruction blocks.

49. The method of claim 46, wherein inserting the profiling instructions comprises:
identifying a starting instruction block and one or more ending instruction blocks in the region of instructions; and
inserting a start instruction in the starting instruction block and one or more end instructions in the one or more ending instruction blocks.

50. The method of claim 46, further comprising:
copying the plurality of path identifiers to a memory.
